(19) United States
(12) Patent Application Publication
(10) Pub. No.: US 2015/0022135 A1
(43) Pub. Date: Jan. 22, 2015

(54) MULTILEVEL INVERTER

(71) Applicant: LSIS CO., LTD., Anyang-si (KR)

(72) Inventor: Hong Min YUN, Anyang-si (KR)

(73) Assignee: LSIS CO., LTD., Anyang-si (KR)

(21) Appl. No.: 14/311,066

(22) Filed: Jun. 20, 2014

(30) Foreign Application Priority Data
Jul. 22, 2013 (KR) 10-2013-0085813

(51) Int. Cl. H02P 27/06

(52) U.S. Cl. CPC H02P 27/06
USPC 318/500

(57) ABSTRACT

The present disclosure discloses a multilevel inverter configured to output a 3-phase voltage to a motor by allowing a plurality of unit power cells forming one phase to be serially connected, the multilevel inverter, the multilevel inverter including a plurality of current sensors configured to detect an output current of the plurality of unit power cells.

### CROSS-REFERENCE TO RELATED APPLICATIONS

Pursuant to 35 U.S.C. §119 (a), this application claims the benefit of earlier filing date and right of priority to Korean Patent Application No. 10-2013-0085813, filed on Jul. 22, 2013, the contents of which are all hereby incorporated by reference in its entirety.

### BACKGROUND OF THE DISCLOSURE

1. Field

The teachings in accordance with the exemplary embodiments of this present disclosure generally relate to a multilevel inverter.

2. Background

Medium voltage high capacity multilevel inverters have emerged from development demands on medium voltage power conversion for promotion and operation of efficient and flexible power systems in electric power industries such as FACTS (Flexible AC Transmission System) devices. Recently, interests in multilevel inverters have increased as multilevel inverter topologies.

Some of the known types of configurations for multilevel inverters are cascaded H-bridge, diode-clamped and flying capacitor multi-level inverters. The cascaded H-bridge inverter is configured by unit cells having independent DC links by serially connected low voltage H-bridge inverters, where a sum of voltages of each cell equals to a sum of inverter outputs, and the output voltages may vary according to the number of cells. However, the cascaded H-bridge inverter topology suffers from disadvantage that independent DC link power must be supplied.

FIG. 1 is a block diagram schematically illustrating a cascaded H-bridge inverter topology according to prior art.

Referring to FIG. 1, the cascaded H-bridge inverter topology according to prior art includes a master controller (130) and a cell controller (not shown) inside a plurality of cells (120), where control is performed by the master controller (120) and the cell controller, both of which are connected to a high speed link, whereby data is transmitted and received.

The master controller (120) receives a motor speed and an output current of the inverter to perform the motor speed and current control, and transmits to the cell controller by synchronizing 3-phase voltage levels for each phase. The cell controller generates a PWM (Pulse Width Modulation) using DC link voltages of each cell (120) and voltage levels received from the master controller (120). The master controller (120) in the conventional cascaded H-bridge inverter detects, from a motor (200), a current of each phase for safe acceleration/deceleration of the motor (200) and a current sensor (140) is provided to this end.

The current sensor (140) used for the motor (200) according to prior art is a current-type current sensor instead of voltage-type current sensor due to the fact that a final insulation voltage is equal to a voltage of the motor (120) and a detection length of the current sensor (140) is very long. Furthermore, the current-type current sensor is robust to noise.

That is, selection of detection current sensor is restricted due to pre voltage and current conditions, and there is no way to cope with hardware loss as only one element for detecting the current of each phase is available.

### SUMMARY OF THE DISCLOSURE

The present disclosure is to provide a multilevel inverter configured to detect a current of the multilevel inverter using a general purpose current detection element by providing a same current to serially connected cells and detecting a current from each cell.

Furthermore, the present disclosure is to provide a multilevel inverter configured to be applied with a current detection element regardless of restrictive conditions relative to voltage and current conditions and noise.

In one general aspect of the present disclosure, there is provided a multilevel inverter configured to output a 3-phase voltage to a motor by allowing a plurality of unit power cells forming one phase to be serially connected, the multilevel inverter comprising: a plurality of current sensors configured to detect an output current of the plurality of unit power cells.

Preferably, but not necessarily, the multilevel inverter may further comprise a master controller configured to transmit voltage level information to the unit power cells by receiving an output current of the plurality of unit power cells.

Preferably, but not necessarily, the unit power cell may include a rectifier configured to rectify an inputted AC voltage to a DC voltage, a DC link capacitor configured to smooth an output voltage of the rectifier, a cell controller configured to generate a PWM (Pulse Width Modulation) signal in response to the voltage level information received from the master controller, an inverter unit configured to convert a DC voltage of the DC link capacitor to an AC voltage to be outputted to a motor in response to the PWM signal of the cell controller, and the current sensor configured to detect an output current of the inverter unit.

Preferably, but not necessarily, the inverter unit may include a plurality of semiconductor devices, and the current sensor may detect a current outputted from the plurality of semiconductor devices.

Preferably, but not necessarily, the current sensor may detect the output current of the inverter unit and may provide the output current to the master controller.

### Advantageous Effects of the Disclosure

The multi-level inverter system according to the present disclosure thus described has an advantageous effect in that system reliability can be enhanced by outputting a same set performance even if there is generated hardware defect when a system is formed, and maintenance cost of the system can be reduced due to no separate set change.

Another advantageous effect is that a current can be detected for each set to allow detecting a current safely relative to voltage, and a more accurate value can be detected.

### BRIEF DESCRIPTION OF DRAWINGS

FIG. 1 is a schematic block diagram illustrating a cascade H-bridge inverter according to prior art.

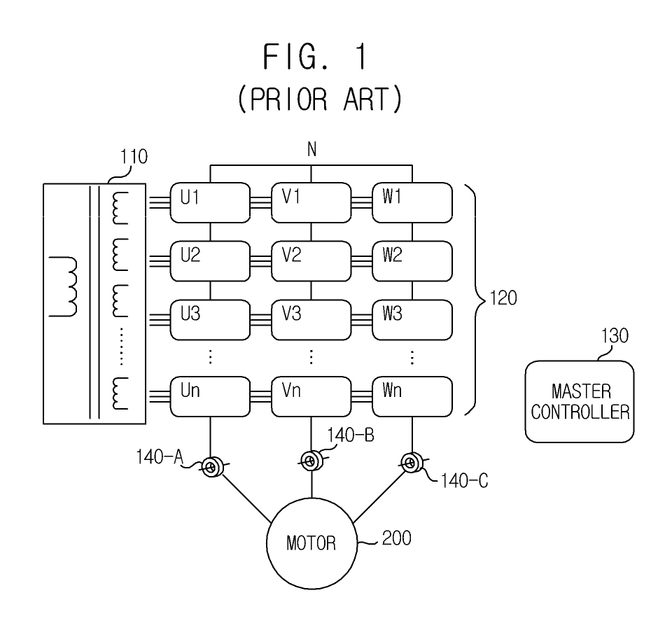

FIG. 2 is a schematic block diagram illustrating a multilevel inverter according to an exemplary embodiment of the present disclosure.

FIG. 3 is a detailed block diagram illustrating each cell of FIG. 2.

### DETAILED DESCRIPTION OF THE DISCLOSURE

Various exemplary embodiments will be described more fully hereinafter with reference to the accompanying drawings, in which some exemplary embodiments are shown. The present inventive concept may, however, be embodied in many different forms and should not be construed as limited to the example embodiments set forth herein. Rather, the described aspect is intended to embrace all such alterations, modifications, and variations that fall within the scope and novel idea of the present disclosure.

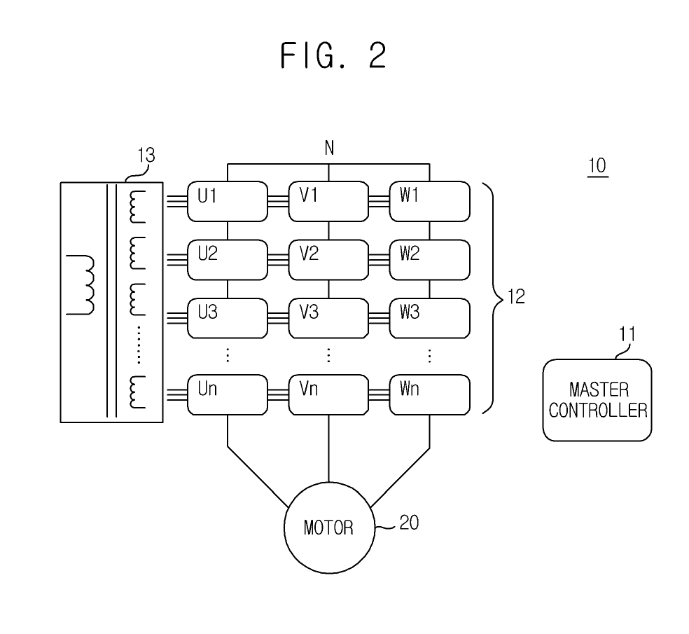

FIG. 2 is a schematic block diagram illustrating a multilevel inverter according to an exemplary embodiment of the present disclosure.

Although the multilevel inverter according to the present disclosure explains a cascaded H-bridge inverter, for example, the present disclosure is not limited thereto, and the present disclosure may be applied to other types of inverters.

Referring to FIG. 2, a multilevel inverter (10) according to the present disclosure is configured to control a motor (20) and includes a master controller (11), a plurality of unit power cells (hereinafter referred to as “cells”, 12) and a phase shift transformer (13).

The phase shift transformer (13) is configured to supply an independent electric power to each cell (12). The detailed explanation on configuration of the phase shift transformer will be omitted as it is not directly related to the present disclosure.

The plurality of cells (12) includes a cell (U1, U2, . . . Un) forming a U phase, a cell (V1, V2, . . . Vn) forming a V phase and a cell (W1, W2, . . . Wn) forming a W phase, where the cells are serially connected to provide each phase, and a sum of outputs of these cells may be multilevel output voltages for driving the motor (20). The number of cells forming a cell may be determined by the output voltages.

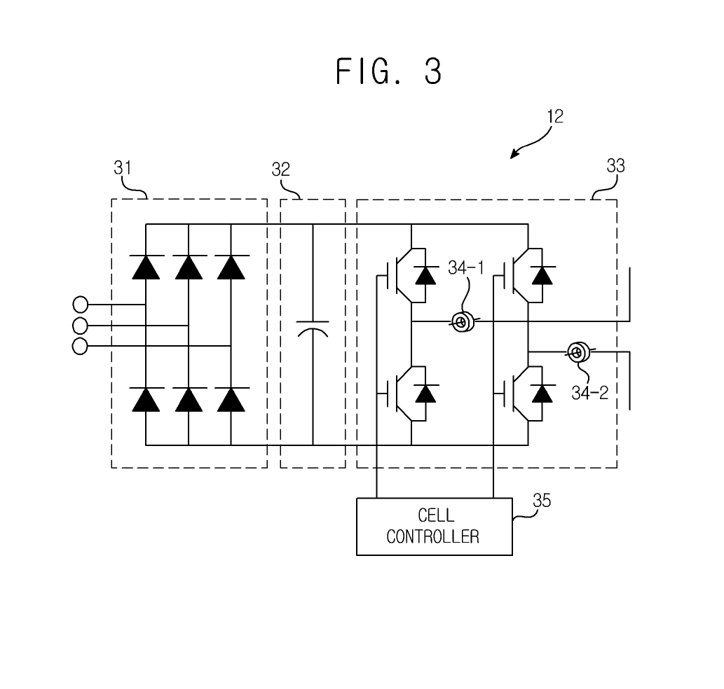

FIG. 3 is a detailed block diagram illustrating each cell of FIG. 2, where only one cell is described as each configuration of the plurality of cells is same. Referring to FIG. 3, the unit power cell (12) according to the present disclosure includes a rectifier (31), a DC link capacitor (32), an inverter unit (33), a current sensor (34) and a cell controller (35).

The rectifier (31) rectifies an AC voltage inputted from the phase shift transformer (13) to a DC voltage, and the DC link capacitor (32) smoothes the DC voltage inputted from the rectifier (31). The rectifier (31) may be formed with a plurality of diodes.

The inverter unit (33) generates an AC voltage to be outputted to the motor (20) in response to PWM control of the cell controller (35), and outputs the AC voltage, and may be formed by a plurality of IGBTs (Insulated Gate Bipolar Transistors), for example. The current sensor (34) may detect a current outputted from the plurality of semiconductor devices of the inverter unit (33), and provide the current to the master controller (11). Although the master controller (11) of FIG. 2 is illustrated as being formed independently from the plurality of cells (12), it is for the simplicity of drawing, and the master controller (11) and the cell controller (35) of the plurality of cells (12) may be connected via optical communication for insulation and reduction in noise.

The master controller (11) receives an output voltage from the plurality of cells and in turn transmits voltage level information to the cells (12). Each cell (12) may apply an output voltage corresponding to the DC link voltage to the motor (20) which is a load, generates a PWM signal in response to the voltage level information, whereby frequency applied to the motor (20) can be varied to obtain a starting torque and control a motor speed at the same time.

The multilevel inverter (10) according to the present disclosure is configured such that the current sensor (34) is arranged respectively on the plurality of cells (12) forming a phase voltage inputted to the motor (20) and detects an output current of the inverter unit (33) in the plurality of cells (12).

By the configuration thus described, each cell may use a voltage type current sensor because noise level is lower than that of the entire multilevel inverter (10), and therefore, a detection length is short and power supply is smooth because the current detection is performed by the cells (12). Furthermore, an over-current protection for each cell (12) is possible to thereby enable a build-up of reliable system.

In addition, a current flowing from each phase to the cell (12) is same, and even if one cell is inoperative, a continuous current detection is enabled, and the master controller (11) can more accurately transmit control information to the cell controller (35) because the current information of cells (12) is transmitted to the master controller (11).

Still furthermore, a general purpose voltage type current sensor can be used in comparison to a current sensor of an inverter unit to thereby reduce costs over the conventional large capacity current sensor, and because a dielectric withstanding voltage to the current sensor is limited to the cell voltage, no additional insulation reinforcement is required.

Although the present disclosure has been described in detail with reference to the foregoing embodiments and advantages, many alternatives, modifications, and variations will be apparent to those skilled in the art within the metes and bounds of the claims. Therefore, it should be understood that the above-described embodiments are not limited by any of the details of the foregoing description, unless otherwise specified, but rather should be construed broadly within the scope as defined in the appended claims

What is claimed is:

1. A multilevel inverter configured to output a 3-phase voltage to a motor by allowing a plurality of unit power cells forming one phase to be serially connected, the multilevel inverter comprising:
a plurality of current sensors configured to detect an output current of the plurality of unit power cells.

2. The multilevel inverter of claim 1 may further comprise a master controller configured to transmit voltage level information to the unit power cells by receiving an output current of the plurality of unit power cells.

3. The multilevel inverter of claim 2, wherein the unit power cell includes a rectifier configured to rectify an inputted AC voltage to a DC voltage, a DC link capacitor configured to smooth an output voltage of the rectifier, a cell controller configured to generate a PWM (Pulse Width Modulation) signal in response to the voltage level information received from the master controller, an inverter unit configured to convert a DC voltage of the DC link capacitor to an AC voltage to be outputted to a motor in response to the PWM signal of the cell controller, and the current sensor configured to detect an output current of the inverter unit.

4. The multilevel inverter of claim 3, wherein the inverter unit includes a plurality of semiconductor devices, and the current sensor detects a current outputted from the plurality of semiconductor devices.

5. The multilevel inverter of claim 3, wherein the current sensor detects the output current of the inverter unit and provides the output current to the master controller.

6. The multilevel inverter of claim 4, wherein the current sensor detects the output current of the inverter unit and provides the output current to the master controller.

7. The multilevel inverter of claim 1, wherein the current sensor is a voltage type current sensor.

8. The multilevel inverter of claim 2, wherein the current sensor is a voltage type current sensor.

9. The multilevel inverter of claim 3, wherein the current sensor is a voltage type current sensor.

10. The multilevel inverter of claim 4, wherein the current sensor is a voltage type current sensor.

11. The multilevel inverter of claim 5, wherein the current sensor is a voltage type current sensor.

12. The multilevel inverter of claim 6, wherein the current sensor is a voltage type current sensor.
